(19) United States
(12) Patent Application Publication
(10) Pub. No.: US 2005/0137000 A1
(43) Pub. Date: Jun. 23, 2005

(54) Rotatable latching device for a housing of a portable electronic device

(76) Inventors: Kok Wah Toh, Singapore (SG); Tatt Hoong Chow, Singapore (SG); Manoj Govindan, Singapore (SG); Yik Bin Lee, Singapore (SG); Boon Kiat Teo, Singapore (SG)

Correspondence Address: MOTOROLA INC, 600 NORTH US HIGHWAY 45, ROOM AS437, LIBERTYVILLE, IL, 60048-5343, US

(21) Appl. No.: 10/743,211

(22) Filed: Dec. 22, 2003

(51) Int. Cl. H04M 1/00

(52) U.S. Cl. 455/575.4; 455/575.1; 455/575.3

(57) ABSTRACT

A rotatable latching device (1) for a portable electronic device (60) having a two part housing wherein a first housing member (42) rotates relative to a second housing member (41) about an axis (50) substantially perpendicular to a front surface (61) of the device. The latching device (1) has a body (2) securable within and to the second housing member (41) and the first housing member (42) is mounted to a rotatable cam element (3) located within the body (2) and is rotatable with the cam element (3) continuously from a closed position to an open position 180° to the closed position by a torsion spring (4) after manually disengaging a latchable detent follower (10). During manual return from an open position to a closed position, housing member (41) is latchable in an intermediate position at 90° to a closed position to enable selective viewing of a display mounted to said first housing member (42).

### FIELD OF THE INVENTION

This invention is concerned with latching devices and two part housings for portable electronic employing such latching devices wherein one housing member is movable between an open and closed position.

The invention is concerned particularly although not exclusively with two part housing latching devices and two part housings for a wireless communications device wherein one housing member is rotatable relative to the other housing member about a rotational axis perpendicular to a front surface of the device.

### BACKGROUND ART OF THE INVENTION

Portable electronic devices these days offer a wide range of functionalities to suit the diverse needs of users of such devices. Whilst incorporating a greater range of functionalities into such devices, there has been a strong trend to miniaturisation to enable the devices to be more conveniently carried by a user, whether in a pocket or a purse, whether carried on a belt clip or even on a lanyard suspended from a user's neck.

There are, however, practical limitations to the extent to which many such portable electronic devices can be miniaturised without interfering with ease and convenience of use. For example, while a keypad readily may be miniaturised, it becomes difficult to operate with a user's fingers without errors due to simultaneous touching of closely adjacent keys. With miniaturised keypads, there is usually associated miniaturised indicia on or adjacent the keys which may make it difficult for some users to readily identify the particular functions of keys. Importantly however, miniaturisation of keypads in particular makes it much more difficult for a user to operate the device with a single hand. Where telephone handsets are concerned, there is a requirement to have a microphone and speaker spaced sufficiently to accommodate a user's mouth and ear, respectively.

In order to satisfy the conflicting requirements of compactness and ease and convenience of use, manufacturers have developed electronic devices with two part housings which are extensible in length by a telescopic sliding movement between the two housing members or a hinged joint between the housing members to enable the housing to be unfolded to an extended position or folded to a closed position.

A limitation of telescopically extendible two part housings is that to retain a robust coupling of the housing members, a substantial degree of overlap must be retained in the extended position, thereby substantially limiting the amount by which the housing may be extended.

Clam shall designs incorporating a main housing member and a flip type cover hinged along a top edge have proven popular as it is possible to increase the length of the device by a factor of two when the flip cover is in an open position. The flip cover also provides a convenient form of protection for a keypad located on the upper surface of the main housing member. In this configuration, the pivotal axis of the hinged coupling between the main housing member and the flip cover member is parallel to the front surface of the main housing member and extends transversely along an upper edge thereof. One such prior art device embodies a digital camera and also an LCD display located on an inner face of the flip cover member. When the flip cover member is pivoted to an open, extended position, the flip cover member is rotatable through 180° about a longitudinal axis of the flip cover member, the axis being substantially parallel to the face of the LCD display.

With most of the prior art flip type or clam shell two part housings, a spring biasing device is employed to retain the flip cover member in an open and/or closed state. One such device incorporates a cam member such that initially, the flip cover member is moved towards an open position against a biasing influence of the spring device and about half way through the travel of the flip cover member towards an open position, the cam member associated with the spring device goes through a neutral position into an over-centre position whereby the spring device urges the flip cover member towards the open position. While generally suitable for its intended purpose, such portable electronic devices require a two handed operation, at least to open the flip cover member.

Other known flip type or clam shell devices incorporate a unidirectional spring device which biases the flip cover member to an open position and a latch member to retain the flip cover member in a closed position against the biasing influence of the spring device. Flip type or clam shell portable electronic devices incorporating a latch are generally able to be opened with one hand.

A disadvantage with flip type or clam shell portable electronic devices having a spring biased flip cover member is that robust stop members are required to avoid damage to the flip cover member and its associated hinge as it reaches the limit of its open position. Moreover, even robust latch mechanisms are prone to wear or breakage which can render an otherwise fully functional portable electronic device as useless or too inconvenient for further use, particularly when the flip cover member is coupled to an on-off switch for the device.

In order to overcome or alleviate at least some of the problems associated with prior art portable electronic devices having extendible two part housings, recently it has been proposed to pivotally couple first and second housing members such that the housing members are able to undergo relative rotation about a pivotal axis extending substantially perpendicular to a front surface of the device. The cover member is manually rotated between the closed and open positions.

### SUMMARY OF THE INVENTION

According to one aspect of the invention, there is provided a rotatable latching device for a portable electronic device having a two part housing wherein a first housing member rotates relative to a second housing member about an axis substantially perpendicular to a front surface of said device, said latching device including:
a body having a rotatable cam element, said cam element in use being urged to rotate about a rotational axis between a closed position and an open position by a torsional biasing member; and
a latchable detent follower selectively engageable with said cam element to retain cam element in said open or closed position against a restoring force applied by said torsional biasing member, said cam element being rotatable at least partially from an open position to disengage said detent follower to allow said cam element to selectively engage said detent follower at an intermediate position between, said open position and said closed position against the influence of said torsional biasing member.

Suitably, said cam element comprises a substantially circular member having at least one detent engaging surface adjacent a circumferential edge of said substantially circular member.

Preferably, said cam element comprises two or more circumferentially spaced detent engaging surfaces.

Said detent engaging surfaces may be formed on a radially outwardly extending protrusion on said cam element.

Said detent engaging surfaces may be radially inwardly extending recesses on said cam element.

Preferably, said detent engaging surfaces are at least partially complementary to an engaging surface of a detent follower of said detent follower.

The detent follower may be resiliently biased in a direction radially inwardly of said cam element.

Suitably, said detent follower may be selectively latchable in a retracted position by a releasable resiliently biased latching mechanism.

If required, the detent follower may be urged from an extended unlatched position to a retracted latched position by at least partial rotation of said cam element from said closed position to urge said radially outwardly extending protrusion into engagement with said detent follower whereby said cam element is urged to rotate to said open position under the influence of the restoring force of said torsional biasing member.

The latching mechanism may include a trip mechanism actuable as said cam element approaches said open position to release said detent follower to an unlatched position to engage with a further detent engaging surface to retain said cam element in said open position against the restoring influence of said torsional biasing member.

Suitably, said further detent engaging surface comprises a radially inwardly extending recess.

If required, said cam element may be retainable at at least one intermediate position between said closed position and said open position by a respective at least one radially inwardly extending recess on said cam element.

Suitably, said open position is located at from 150° to 210° from said closed position.

Preferably, said at least one intermediate position is located at from 70° to 110° from said closed position.

The body of said rotatable latching device may include an upright at least partially continuous wall surface to rotatably locate said rotatable cam element.

Suitably, said body includes at least one mounting member to secure said latching device in a housing member.

Preferably, at least a portion of said cam element is exposed via an aperture in said body to permit attachment of a housing member to said cam element for rotation therewith.

According to another aspect of the invention, there is provided a portable electronic device having a two part housing wherein a first housing member rotates relative to a second housing member about an axis substantially perpendicular to a front surface of said device, said latching device including:
a body having a rotatable cam element, said cam element in use being urged to rotate about a rotational axis completely between a closed position and an open position by a torsional biasing member; and
a latchable detent follower selectively engageable with said cam element to retain cam element in said open or closed position against a restoring force applied by said torsional biasing member, said cam element being rotatable at least partially from an open position to disengage said detent follower to allow said cam element to selectively engage said detent follower at a said open position and said closed position against the influence of said torsional biasing member, said body being securable to one of said first or second housing members and said cam element being securable to another of said first or second housing members.

Suitably, said cam element comprises a substantially circular member having at least one detent engaging surface adjacent a circumferential edge of said substantially circular member.

Preferably, said cam element comprises two or more circumferentially spaced detent engaging surfaces.

Said detent engaging surfaces may be formed on a radially outwardly extending protrusion on said cam element.

Said detent engaging surfaces may be formed on a radially inwardly extending recess on said cam element.

Suitably, said detent follower may be selectively latched in a retracted position by a releasable resiliently biased latching mechanism.

If required, the detent follower may be urged from an extended unlatched position to a retracted latched position by at least partial rotation of said cam element from said closed position to urge said radially outwardly extending protrusions into engagement with said detent follower whereby said cam element is urged to rotate to said open position under the influence

Suitably, said detent follower may be selectively latched in a retracted position by a releasable resiliently biased latching mechanism.

If required, the detent follower may be urged from an extended unlatched position to a retracted latched position by at least partial rotation of said cam element from said closed position to urge said radially outwardly extending protrusions into engagement with said detent follower whereby said cam element is urged to rotate to said open position under the influence of the restoring force of said torsional biasing member.

Preferably, said electronic device incorporates at least one display screen.

Suitably, said electronic device incorporates a display screen on an outer face of said first housing member, said first housing member being selectively rotatable relative to said second housing member to orient said display screen in a portrait or landscape configuration.

If required, said electronic device may include a digital camera device.

### BRIEF DESCRIPTION OF THE DRAWINGS

In order that the invention may be more fully understood, and put into practical effect, reference will now be made to the preferred embodiments illustrated in the accompanying drawings, in which:

FIG. 1 shows an exploded view of a rotatable latching device according to one aspect of the invention;

FIG. 2 shows one side of the device of FIG. 1 in an assembled state;

FIG. 3 shows an opposite side of the device of FIG. 2

FIGS. 4 to 8 show schematically the operation of the latching device;

FIG. 9 shows a front view of a portable electronic device according to the invention when in a fully open position;

FIG. 10 shows a rear view of the portable electronic device of

### DETAILED DESCRIPTION OF THE PREFERRED EMBODIMENT OF THE INVENTION

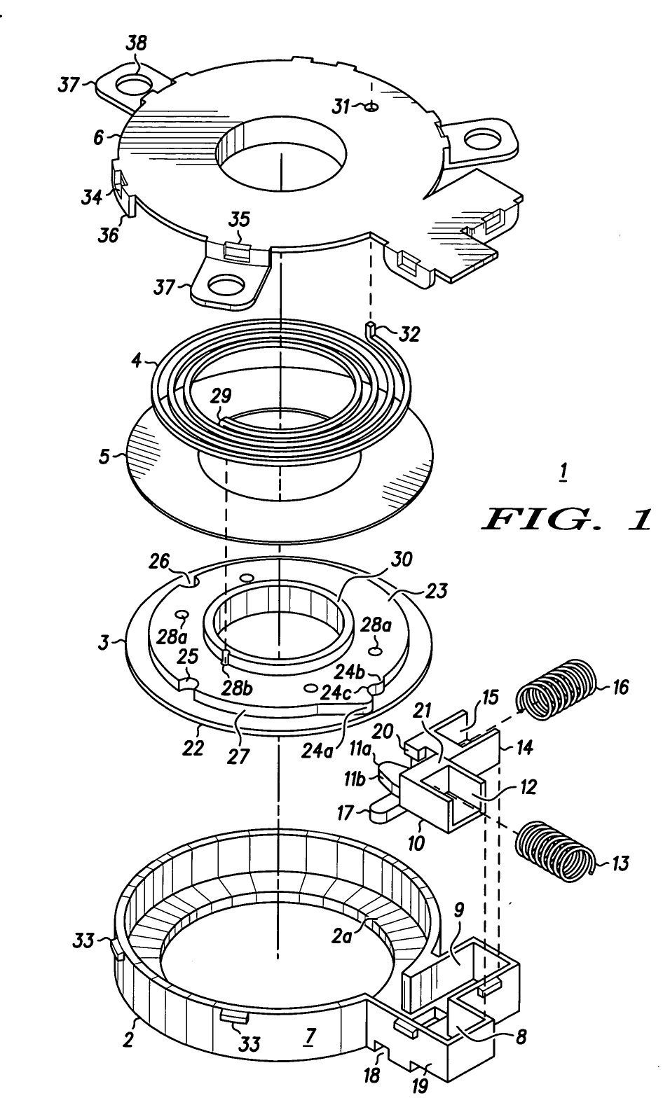

In the description of the preferred embodiments illustrated in the accompanying drawings, like reference numerals will be employed for like features where appropriate. FIG. 1 shows a rotatable latching device 1 comprising a body 2, a substantially circular rotatable cam element 3, a torsional biasing member 4 in the form of a coil spring, a bearing plate 5 and a cover plate 6. Body 2 comprises an annular retaining flange 2a and a substantially circular outer wall 7 with a radially extending detent follower cavity 8 projecting therefrom. Extending perpendicularly to and communicating with detent follower cavity 8 is a latch mechanism cavity 9.

A detent follower 10, locatable in cavity 8, includes a nose member 11a having an engaging surface 11b formed on an edge of the nose member 11a. A hollow recess 12 extending rearwardly of detent follower 10 receivably locates a resilient biasing member 13 in the form of a compressible coil spring. A latching mechanism 14 also has a hollow recess 15 extending rearwardly thereof to receivably locate a resilient biasing member 16 in the form of a compressible coil spring. A trip mechanism 17 mounted on a front portion of latching mechanism 14 extends slidingly beneath detent follower 10 and in use extends outwardly from an aperture 18 formed in a side wall 19 of detent follower cavity 8. A shouldered projection 20 is releasably engageable with a front wall 21 of detent follower 10.

Rotatable cam element 3 comprises a substantially circular member 22 having a raised substantially circular boss 23 concentric therewith. Boss 23 includes adjacent cam like projections 24a and 24b with a nadir 24c therebetween. There are also spaced detent engaging surfaces in the form of tapering recesses 25,26 spaced circumferentially in an upright wall 27 (forming a circumferential edge) of boss 23. A plurality of mounting apertures 28a are spaced circumferentially between wall 27 and a central locating flange 30 for mounting latching device 1 to a first housing member of a portable electronic device such as cellphone. Also, one end 29 of torsional biasing member 4 is locatable in an aperture 28b of cam element 3. The opposite end 32 of torsional biasing member 4 protrudes locates in an aperture 31 in cover plate 6. This therefore allows a torsional restoring force between rotatable cam element 3 and body 2 when assembled with cover plate 6 secured to body 2 by engagement between tapered abutments 33 formed about the periphery of body 2 and slotted recesses 34, 35 formed respectively in attachment flanges 36 and mounting flanges 37, respectively.

Mounting flanges 37 include apertures 38 to permit attachment of the device 1 to a second housing member of a portable electronic device. Bearing plate 5 is configured and positioned such that when the latching device 1 is assembled, torsional biasing member 4 is constrained to be in an annular space defined by the top surface of bearing plate 5 and a lower surface of cover plate 6.

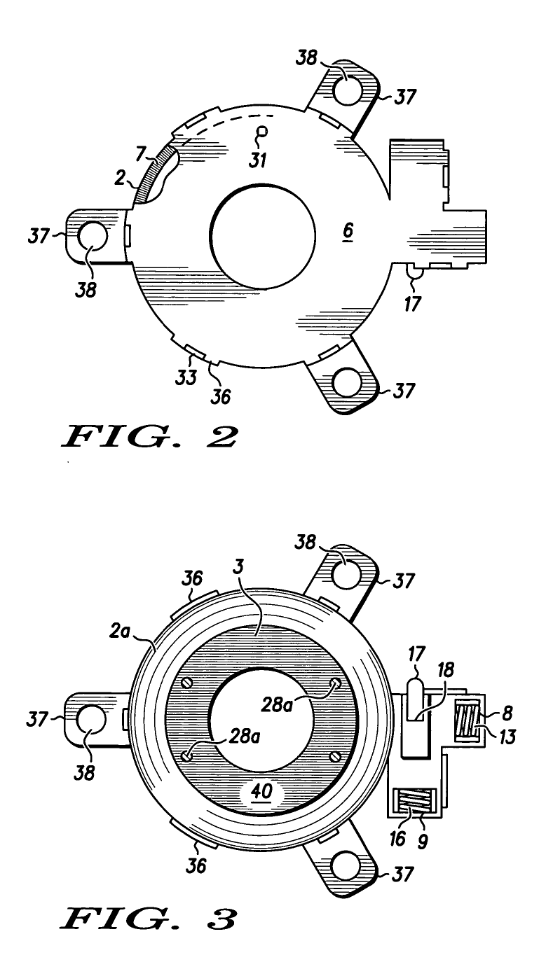

FIG. 2 shows the latching device 1 of FIG. 1 in an assembled state with cover plate uppermost.

FIG. 3 shows the assembled latching device of FIG. 2 in an inverted state with a lower surface portion 40 of cam element 3 protruding through a central aperture surrounded by retaining flange 2a. Flanges 37 facilitate mounting of the latching device 1 in the second housing member of a portable electronic device. Apertures 28a in the exposed surface of cam element 3 permit attachment of device 1 in the first housing member to allow relative rotation of the respective housing members by rotation of cam element 3 within body 2.

Referring generally to FIGS. 4 to 8 there is illustrated schematically the operation of the latching device 1 of FIGS. 1 to 3 located in a portable electronic device comprising the first housing member 42 and the second housing member 41. For ease of explanation and understanding, cover plate 6, biasing member 4 and bearing plate 5 are removed from FIGS. 4 to 8. In this embodiment housing member 42 is a front housing member of the portable electronic device. As shown specifically in FIG. 4, the housing members 41, 42 are in a closed state and are maintained in that closed state against a preloaded restoring force of torsional biasing member 4 (shown in FIG. 1).

The latching device 1 is mounted in housing member 41 and housing member 42 is secured on the exposed portion of cam element 3 thereunder. Rotation of housing member 42 relative to housing member 41 against the restoring force of preloaded torsional biasing member 4 (shown in FIG. 1) is resisted by engagement between nose member 11 of detent follower 10 and cam like projection 24 on cam element 3. As shown in FIG. 4, the latching device 1 is in the closed position or state. In the closed position the nose member 11a of detent follower 10 is located in the nadir 24c and thus the detent follower is in co-acting and engagement with projection 24a and nadir 24c. Also, the detent follower 10 is urged into engagement with cam element 3 under the influence of biasing member 13 and the shouldered projection 20 on latching mechanism 14 engages against front wall 21 of detent follower 10 under the influence of biasing member 16. A stop member 45 (shown in phantom) is secured to housing member 42 between housing members 41 and 42. Stop member 45 has a trip mechanism actuator 45a extending therefrom, the purpose of which will be described later.

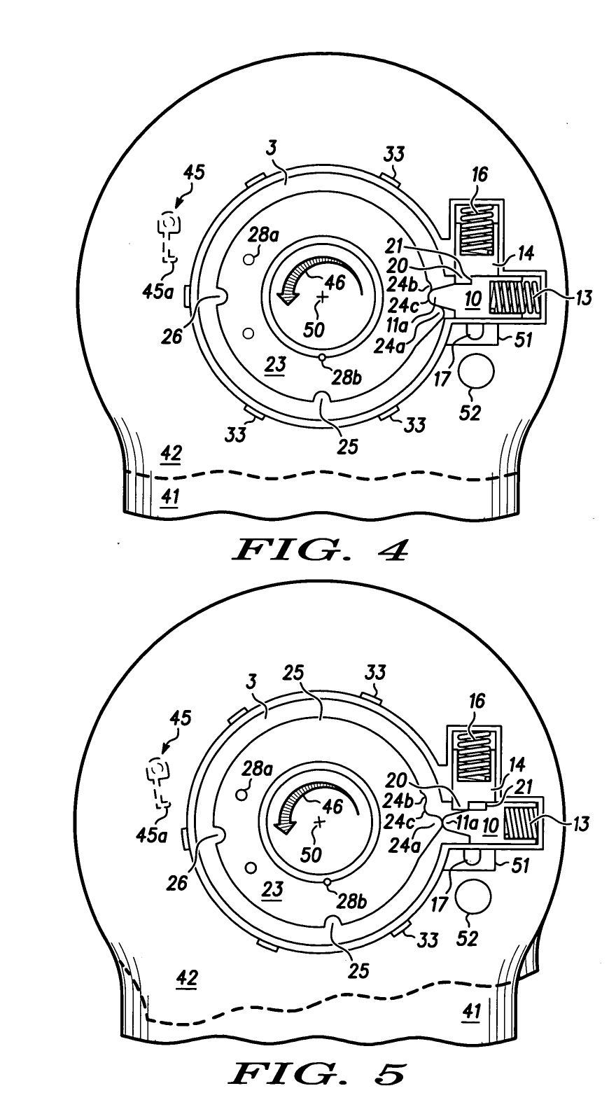

FIG. 5 shows release of co-acting retention and engagement of the detent follower 10 and protrusion 24a by manual rotation of housing member 42 (shown in FIG. 4) through about 5°-7° relative to housing member 41 in the direction shown by arrow 46. In this position it will be noted that nose member 11a has moved out of nadir 24c up to the zenith of projection 24a and detent follower 10 is urged radially outwardly from cam element 3 against the restoring influence of biasing member 13. Once the detent follower 10 has moved over the zenith of projection 24a, by manual rotation of housing member 42 through about 10°-15°, the detent follower 10 is disengaged from cam element 3. In other words cam element 3 and detent follower 10 are latchingly disengaged from the closed position and housing member 42 is free to rotate in the direction of arrow 46 relative to housing member 41 towards an open position under the influence of the restoring force of torsional biasing member 4 (shown in FIG.1). As will be apparent to a person skilled in the art, the open position is typically located between 150° to 210° from the closed position and it is usually located 180° from the closed position.

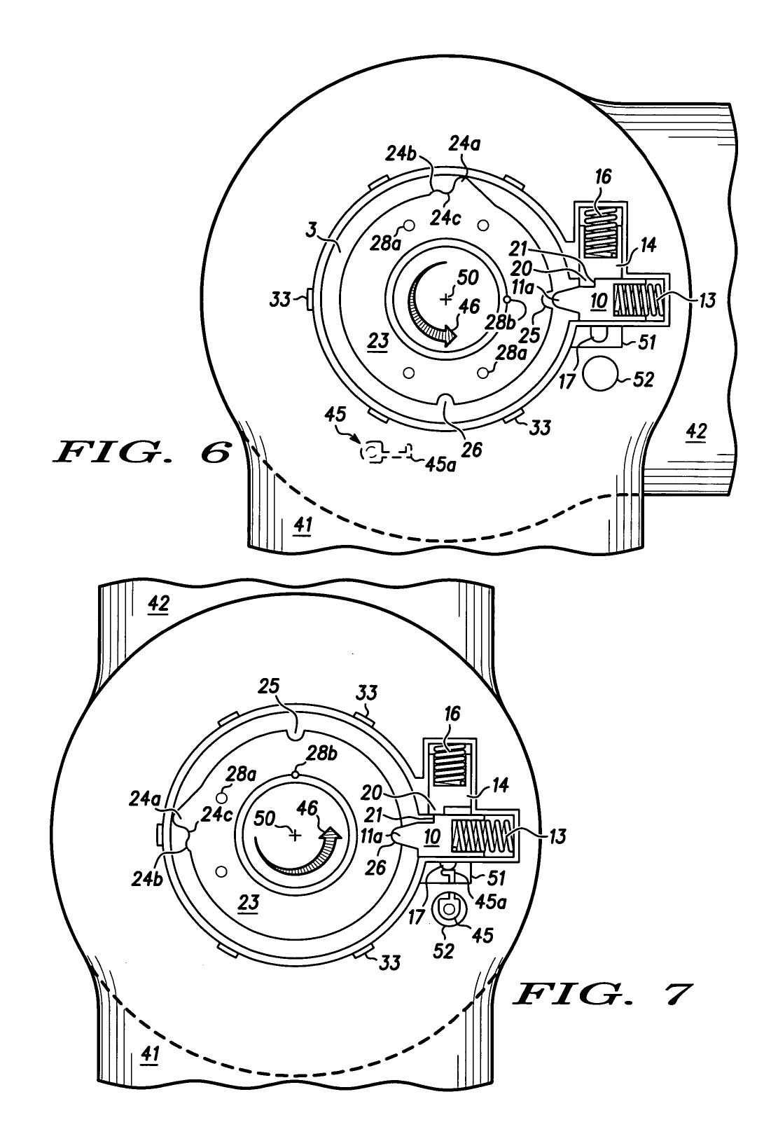

FIG. 6 shows housing member 42 orientated at about 90° relative to housing member 41 as housing member 42 rotates, about a rotational axis 50, towards an open position. It will be noted that nose member 11a of detent follower 10 is retained in a retracted position by latching mechanism 14 as recessed aperture 54 in boss 23 passes nose member 11a of detent follower 10 and housing member 42 continues to rotate relative to housing member 41 unimpeded.

FIG. 7 shows cam element 3 latched in an extended or open position 180° from the initial latched closed position shown in FIGS. 4 and 5.

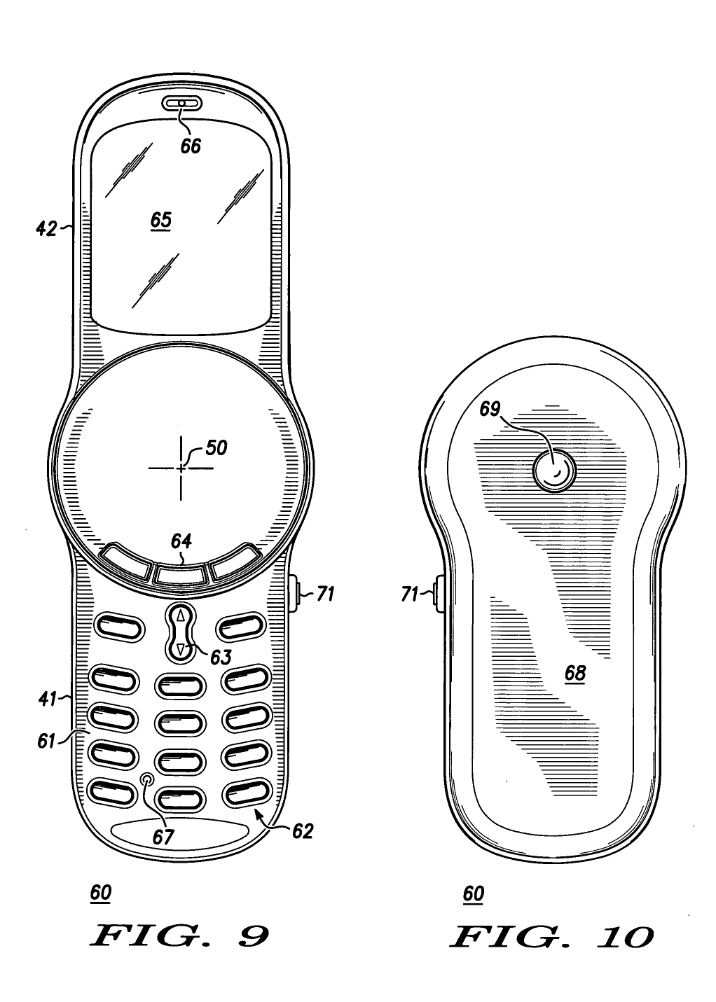

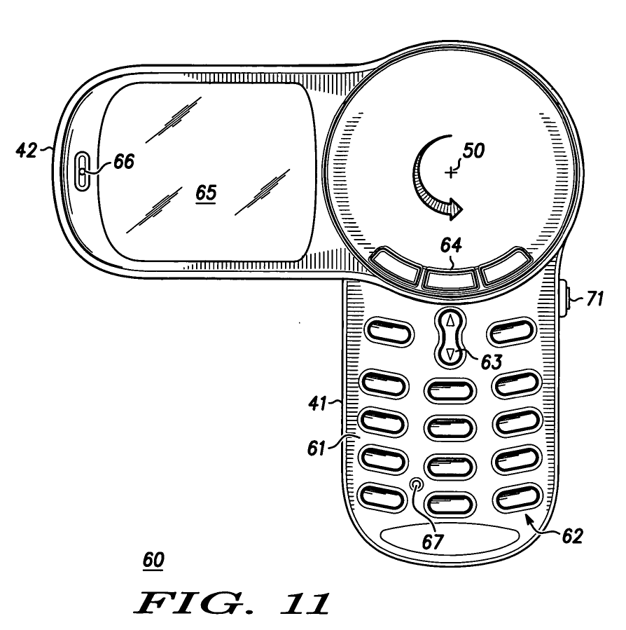

As housing member 42 rotates past the 90° position shown in FIG. 6 it will be seen that stop member 45 (visible via an aperture 52 in housing member 41) and trip mechanism actuator 45a are positioned at substantially the same radial distance from the rotational axis 50 of cam element 3 as is trip mechanism 17. When trip mechanism actuator 45a (visible via an aperture 51 in housing member 41) engages trip mechanism 17 it causes latching mechanism 14 to retract against the biasing influence of biasing member 16 to disengage shouldered projection 20 from the front wall 21 of detent follower 10. Detent follower 10, under the influence of biasing member 13 is urged radially inwardly until it engages in recess 26 in boss 23 as shown in FIG. 7. By virtue of the connection of housing member 42 to cam element 3, the housing members 41, 42 of the device, typically a cellphone, adopt the configuration shown generally in FIG. 9 whereupon the device may be used in its extended or open position.

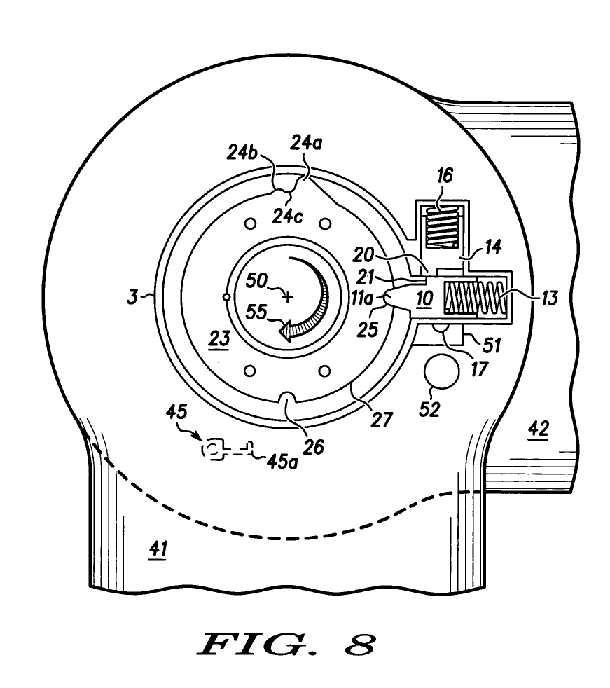

After use, housing member 42 of the cellphone may then be rotated relative to housing member 41 in an opposite direction towards a closed position as shown by arrow 55 in FIG. 8. Initially as housing member 42 starts to move from its latched open position as shown in FIG. 7, manual pressure on housing member 42 causes follower 10 to be urged radially outwardly by a cam action between an inner wall surface of recess 26 and a corresponding edge of nose member 11a. The tip of nose member 11a moves radially outwardly until it engages wall 27 of boss 23. Then as housing member 42 continues to be rotated in the direction of arrow 55, shown in FIG. 8, against the restoring force of the torsional biasing member 4 (shown in FIG. 1), the tip of nose member 11a engages the wall surface of boss 23 between recess 26 and recess 25. As shown detent engaging surfaces or recesses 25, 25 are at least partially complementary in shape to the engaging surface of nose member 11a of the detent follower 10. The nose member 11 then enters and engages recess 25 to latch housing member 42 in a 90° orientation if required. This is an intermediate position located 70° to 110° from the closed position and is usually 90° from the closed position. If it is not required to latch housing member 42 in the intermediate position of 90° orientation as shown in FIG. 8, housing member 42 may be moved to the latched closed position as shown in FIG. 4 by manually rotating housing member 42 in the direction of arrow 55 shown in FIG. 8, firstly to disengage detent follower 10 from recess 25 and then to engage projection 24a. As the zenith of projection 24a engages the tip of nose member 11a, detent follower 10 is urged into the retracted position as shown in FIG. 5. In this position, the front wall 21 of detent follower 10 has been retracted sufficiently to enable latching mechanism 14 to move, to an extended position with shouldered projection lying in front of front wall 21. Further rotation of housing member 42 causes projection 24a to move past detent follower 10 which latchingly engages cam element 3 in a closed position. The engagement of the detent follower 10 with nadir 24c ensures that the same closed position (without overrun) is achieved after each opening and closing of the device 1. At the same time, shouldered projection 20 of latching mechanism 14 engages against front wall 21 of detent follower 10 to retain it in a retracted position as shown in FIG. 4.

FIG. 9 shows a front view of a portable electronic device in the form of a cellphone 60, comprising the housing members 41,42, according to the invention when in an extended position. The housing members 41, 42 are rotatable relative to each other about the axis 50 substantially perpendicular to a front surface 61 of housing member 41. A keypad 62 comprises any suitable layout of keys to suit the functions of the cellphone 60 and a number of function switching keys 63 or additional function keys 64 also may be provided. A display 65 is mounted in housing member 42 and in the open position shown it is oriented in a portrait viewing mode. Housing member 42 includes a speaker aperture 66 and housing member 41 includes a microphone aperture 67.

FIG. 10 shows a rear view of the cellphone 60 in a closed position. Located in the rear face 68 of housing member 41 is a lens assembly 69 of a digital camera device coupled to display 65 via a processor embodied in the cellphone.

FIG. 11 shows the cellphone of FIGS. 9 and 10 with housing member 42 latched in an intermediate position between the open position as shown in FIG. 9 and a closed position. In the intermediate position shown, display 65 is viewable in a landscape mode and is latched in that position as shown in FIG. 8 as housing member 42 is rotated in the direction shown from an open position to a closed position.

When the cellphone is in the fully open position as shown in FIG. 9 or in the partially closed intermediate position shown in FIG. 11, the digital camera function of the electronic device may be invoked by, say one of function keys 63,64 whereupon the display 65, suitably a backlit LCD, may be actuated to display the view of lens assembly 69 in a portrait or landscape mode as desired. The digital camera may be actuated by one of the keys on keypad 61 or alternatively a key 71 located on the side of housing member 41.

It readily will be apparent to a person skilled in the art that the rotatable latching device of the invention and portable electronic devices incorporating the latching device provide a convenient yet elegant solution to prior art portable electronic devices incorporating extendible two part housings. In particular, portable electronic devices incorporating the latching device according to the invention are simply and conveniently usable in a one handed operation wherein the front housing member may be gently urged out of its closed latched position by gentle thumb or finger pressure, depending upon in which hand the electronic device is being gripped, whereupon front housing member 42 rotates through 180° about rotational axis 50. Closure of the device is equally easily achieved by a one or two handed operation with the added benefit of selective orientation of the display 65 either in a portrait or landscape mode.

1. A rotatable latching device for a portable electronic device having a two part housing wherein a first housing member rotates relative to a second housing member about an axis substantially perpendicular to a front surface of said device,
said latching device including a body having a rotatable cam element, said cam element in use being urged to rotate about a rotational axis between a closed position and an open position by a torsional biasing member; and,
a latchable detent follower selectively engageable with said cam element to retain cam element in said open or closed position against a restoring force applied by said torsional biasing member, said cam element being rotatable at least partially from an open position to disengage said detent follower to allow said cam element to selectively engage said detent follower at a position intermediate said open position and said closed position against the influence of said torsional biasing member.

2. A latching device as claimed in claim 1 wherein said cam element comprises a substantially circular member having at least one detent engaging surface adjacent a circumferential edge of said substantially circular member.

3. A latching device as claimed in claim 2 wherein said cam element comprises two or more circumferentially spaced detent engaging surfaces.

4. A latching device as claimed in claim 3 wherein said detent engaging surfaces are formed on a radially outwardly extending protrusion on said cam element.

5. A latching device as claimed in claim 3 wherein said detent engaging surfaces are radially inwardly extending recesses on said cam element.

6. A latching device as claimed in claim 3 wherein said detent engaging surfaces are at least partially complementary to an engaging surface of a detent follower of said detent follower.

7. A latching device as claimed in claim 1 wherein said detent follower is resiliently biased in a direction radially inwardly of said cam element.

8. A latching device as claimed in claim 1 wherein said detent follower is selectively latchable in a retracted position by a releasable resiliently biased latching mechanism.

9. A latching device as claimed in claim 8 wherein the detent follower is urgeable from an extended unlatched position to a retracted latched position by at least partial rotation of said cam element from said closed position to urge said radially outwardly extending protrusion into engagement with said detent follower whereby said cam element is urged to rotate to said position under the influence of the restoring force of said torsional biasing member.

10. A latching device as claimed in claim 9 including a trip mechanism actuable as said cam element approaches said open position to release said detent follower to an unlatched position to engage with a further detent engaging surface to retain said cam element in said open position against the restoring influence of said torsional biasing member.

11. A latching device as claimed in claim 10 wherein said further detent engaging surface comprises a radially inwardly extending recess.

12. A latching device as claimed in claim 10 wherein said cam element is retainable at least one intermediate position between said closed position and said open position by a respective at least one radially inwardly extending recess on said cam element.

13. A latching device as claimed in claim 1 wherein said open position is located at from 150° to 210° from said closed position.

14. A latching device as claimed in claim 1 wherein said at least one intermediate position is located at from 70° to 110° from said closed position.

15. A latching device as claimed in claim 1 wherein said body of said rotatable latching device includes an upright at least partially continuous wall surface to rotatably locate said rotatable cam element.

16. A latching device as claimed in claim 1 wherein said body includes at least one mounting member to secure said latching device in a housing member.

17. A latching member as claimed in claim 1 wherein at least portion of said cam element is exposed via an aperture in said body to permit attachment of a housing member to said cam element for rotation therewith.

18. A portable electronic device having a two part housing wherein a first housing member rotates relative to a second housing member about an axis substantially perpendicular to a front surface of said device, said latching device including:
a body having a rotatable cam element, said cam element in use being urged to rotate about a rotational axis completely between a closed position and an open position by a torsional biasing member; and,
a latchable detent follower selectively engageable with said cam element to retain cam element in said open or closed position against a restoring force applied by said torsional biasing member, said cam element being rotatable at least partially from an open position to disengage said detent follower to allow said cam element to selectively engage said detent follower at a said open position and said closed position against the influence of said torsional biasing member, said body being securable to one of said first or second housing members and said cam element being securable to another of said first or second housing members.

19. A portable electronic device as claimed in claim 18 wherein said cam element comprises a substantially circular member having at least one detent engaging surface adjacent a circumferential edge of said substantially circular member.

20. A portable electronic device as claimed in claim 19 wherein said cam element comprises two or more circumferentially spaced detent engaging surfaces.

21. A portable electronic device as claimed in claim 18 wherein said detent follower is selectively latched in a retracted position by a releasable resiliently biased latching mechanism.

22. A portable electronic device as claimed in claim 21 wherein the detent follower is urgeable from an extended unlatched position to a retracted latched position by at least partial rotation of said cam element from said closed position to urge said radially outwardly extending protrusions into engagement with said detent follower whereby said cam element is urged to rotate to said open position under the influence of the restoring force of said torsional biasing member.

23. A portable electronic device as claimed in claim 1 wherein the latching mechanism includes a trip mechanism actuable in use by a trip member secured to a housing member attached to said cam element as said cam element approaches said second position to release said detent follower to an unlatched position to engage with a further detent engaging surface to retain said cam element in said open position against the restoring influence of said torsional biasing member.

24. A portable electronic device as claimed in claim 18 including at least one display screen.

25. A portable electronic device as claimed in claim 24 wherein said electronic device includes a display screen on an outer face of said first housing member, said first housing member being selectively rotatable relative to said second housing member to orient said display screen in a portrait or landscape configuration.

26. A portable electronic device as claimed in claim 18 including a digital camera device.
